(19) United States
(12) Patent Application Publication
(10) Pub. No.: US 2009/0056336 A1
(43) Pub. Date: Mar. 5, 2009

(54) Gas turbine premixer with radially staged flow passages and method for mixing air and gas in a gas turbine

(75) Inventors: Ronald James Chila, Greer, SC (US); John Charles Intile, Simpsonville, SC (US); Joseph Citeno, Greenville, SC (US); Mert E. Berkman, Greenville, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/892,891

(22) Filed: Aug. 28, 2007

(51) Int. Cl. F02C 1/00

(52) U.S. Cl. 60/737

(57) ABSTRACT

A burner for use in a combustion system of an industrial gas turbine. The burner includes a fuel/air premixer including a splitter vane defining a first, radially inner passage and a second, radially outer passage, the first and second passages each having air flow turning vane portions which impart swirl to the combustion air passing through the premixer. The vane portions in each passage are commonly configured to impart a same swirl direction in each passage. A plurality of splitter vanes may be provided to define three or more annular passages in the premixer.

### BACKGROUND OF THE INVENTION

The present invention relates to heavy duty industrial gas turbines and, in particular, to a burner for a combustion system in a gas turbine including a fuel/air premixer and structure for stabilizing pre-mixed burning gas in a gas turbine engine combustor.

Gas turbine manufacturers are regularly involved in research and engineering programs to produce new gas turbines that will operate at high efficiency without producing undesirable air polluting emissions. The primary air polluting emissions usually produced by gas turbines burning conventional hydrocarbon fuels are oxides of nitrogen, carbon monoxide, and unburned hydrocarbons. It is well known in the art that oxidation of molecular nitrogen in air breathing engines is highly dependent upon the maximum hot gas temperature in the combustion system reaction zone. The rate of chemical reactions forming oxides of nitrogen (NOx) is an exponential function of temperature. If the temperature of the combustion chamber hot gas is controlled to a sufficiently low level, thermal NOx will not be produced.

One preferred method of controlling the temperature of the reaction zone of a combustor below the level at which thermal NOx is formed is to premix fuel and air to a lean mixture prior to combustion. The thermal mass of the excess air present in the reaction zone of a lean premixed combustor absorbs heat and reduces the temperature rise of the products of combustion to a level where thermal NOx is not formed.

There are several problems associated with dry low emissions combustors operating with lean premixing of fuel and air in which flammable mixtures of fuel and air exist within the premixing section of the combustor, which is external to the reaction zone of the combustor. There is a tendency for combustion to occur within the premixing section due to flashback, which occurs when flame propagates from the combustor reaction zone into the premixing section, or autoignition, which occurs when the dwell time and temperature for the fuel/air mixture in the premixing section are sufficient for combustion to be initiated without an igniter. The consequences of combustion in the premixing section are degradation of emissions performance and/or overheating and damage to the premixing section, which is typically not designed to withstand the heat of combustion. Therefore, a problem to be solved is to prevent flashback or autoignition resulting in combustion within the premixer.

In addition, the mixture of fuel and air exiting the premixer and entering the reaction zone of the combustor must be very uniform to achieve the desired emissions performance. If regions in the flow field exist where fuel/air mixture strength is significantly richer than average, the products of combustion in these regions will reach a higher temperature than average, and thermal NOx will be formed. This can result in failure to meet NOx emissions objectives depending upon the combination of temperature and residence time. If regions in the flow field exist where the fuel/air mixture strength is significantly leaner than average, then quenching may occur with failure to oxidize hydrocarbons and/or carbon monoxide to equilibrium levels. This can result in failure to meet carbon monoxide (CO) and/or unburned hydrocarbon (UHC) emissions objectives. Thus, another problem to be solved is to produce a fuel/air mixture strength distribution, exiting the premixer, which is sufficiently uniform to meet emissions performance objectives.

Still further, in order to meet the emissions performance objectives imposed upon the gas turbine in many applications, it is necessary to reduce the fuel/air mixture strength to a level that is close to the lean flammability limit for most hydrocarbon fuels. This results in a reduction in flame propagation speed as well as emissions. As a consequence, lean premixing combustors tend to be less stable than more conventional diffusion flame combustors, and high level combustion driven dynamic pressure fluctuation (dynamics) often results. Dynamics can have adverse consequences such as combustor and turbine hardware damage due to wear or fatigue, flashback or blow out. Thus, yet another problem to be solved is to control the combustion dynamics to an acceptably low level.

Lean, premixing fuel injectors for emissions abatement are in common use throughout the industry, having been reduced to practice in heavy duty industrial gas turbines for more than two decades. A representative example of such a device is described in U.S. Pat. No. 5,259,184, the disclosure of which is incorporated herein by this reference. Such devices have achieved great progress in the area of gas turbine exhaust emissions abatement. Reduction of oxides of nitrogen, NOx, emissions by an order of magnitude or more relative to the diffusion flame burners of the prior art have been achieved without the use of diluent injection such as steam or water.

As noted above, however, these gains in emissions performance have been made at the risk of incurring several problems. In particular, flashback and flame holding within the premixing section of the device result in degradation of emissions performance and/or hardware damage due to overheating. In addition, increased levels of combustion driven dynamic pressure activity results in a reduction in the useful life of combustion system parts and/or other parts of the gas turbine due to wear or high cycle fatigue failures. Still further, gas turbine operational complexity is increased and/or operating restrictions on the gas turbine are necessary in order to avoid conditions leading to high-level dynamic pressure activity, flashback, or blow out.

In addition to these problems, conventional lean premixed combustors have not achieved maximum emission reductions possible with perfectly uniform premixing of fuel and air.

Dual Annular Counter Rotating Swirler (DACRS) type fuel injector swirlers, representative examples of which are described in U.S. Pat. Nos. 5,165,241, 5,251,447, 5,351,477, 5,590,529, 5,638,682, 5,680,766, the disclosures of which are incorporated herein by this reference, are known to have very good mixing characteristics due to their high fluid shear and turbulence. Referring to the schematic representation in FIG. 1, a DACRS type burner 10 is composed of a converging center body 12 and a counter rotating vane pack 14 defining a radially inner passage 16 and a radially outer passage 18 with respect to the axis 20 of the center body, co-axial passages each having swirler vanes. The nozzle structure is supported by an outer diameter support stem 22 containing a fuel manifold 24 for feeding fuel to the vanes of the outer passage 18.

While DACRS type fuel injector swirlers are known to have very good mixing characteristics, these swirlers do not produce a strong recirculating flow at the centerline and hence frequently require additional injection of non-premixed fuel to fully stabilize the flame. This non-premixed fuel increases the NOx emissions above the level that could be attained were the fuel and air fully premixed.

Swozzle type burners, a representative example of which is described in U.S. Pat. No. 6,438,961, the disclosure of which is incorporated herein by this reference, employ a cylindrical center body which extends down the center line of the burner. The end of this center body provides a bluff body, forming in its wake a strong recirculation zone to which the flame anchors. This type of burner architecture is known to have good inherent flame stabilization.

Referring to FIG. 2, an example of a swozzle type burner is schematically depicted. Air enters the burner 42 at 40, from a high pressure plenum, which surrounds the assembly, except the discharge end 44 which enters the combustor reaction zone.

After passing through the inlet 40, the air enters the swirler or ‘swozzle’ assembly 50. The swozzle assembly includes a hub 52 (e.g., the center body) and a shroud 54 connected by a series of air foil shaped turning vanes 56 which impart swirl to the combustion air passing through the premixer. Each turning vane 56 includes gas fuel supply passage(s) 58 through the core of the air foil. These fuel passages distribute gas fuel to gas fuel injection holes (not shown) which penetrate the wall of the air foil. Gas fuel enters the swozzle assembly through inlet port(s) and annular passage(s) 60, which feed the turning vane passages 58. The gas fuel begins mixing with combustion air in the swozzle assembly 62, and fuel/air mixing is completed in the annular passage, which is formed by a center body extension 64 and a swozzle shroud extension 66. After exiting the annular passage, the fuel/air mixture enters the combustor reaction zone where combustion takes place.

The DACRS and swozzle type burners are both well-established burner technologies. That is not to say, however, that these burners cannot be improved upon. Indeed, as noted above, the DACRS type burners do not typically provide good premixed flame stabilization. Swozzle type burners, on the other hand, do not typically achieve fully uniform premixing of fuel and air.

Referring to FIGS. 3, 4 and 5, U.S. Pat. No. 6,993,916, the disclosure of which is incorporated herein by this reference, discloses a hybrid structure that it adopts features of the DACRS and Swozzle to provide the high mixing ability of an axial flowing counter rotating vane swirler with a good dynamic stability characteristics of a bluff center body. More specifically, FIG. 3 is a cross-section through a burner 110, said burner substantially corresponding to a conventional Swozzle type burner as shown in FIG. 2 except for the structure of the swirler shown in the detail of FIG. 4 and in the perspective view of FIG. 5.

Air 140 enters the burner from a high pressure flow (not illustrated in detail) which surrounds the entire assembly except the discharge end, which enters the combustor reaction zone. Typically the air for combustion will enter the premixer via an inlet flow conditioner (not shown). As is conventional, to eliminate low velocity regions near the shroud wall at the inlet to the swirler, a bell-mouth shaped transition 148 is used between the inlet flow conditioner (not shown) and the swirler 150. The swirler assembly includes a hub 152, a splitter ring or vane 153 and a shroud 154 (omitted from FIG. 5) connected respectively by first and second series of counter-rotating air flow turning vanes 156, 157 which impart swirl to the combustion air passing through the premixer. Thus, the splitter vane 153 defines a first, radially inner passage 116 (with respect to the axis of the center body) with the hub 152 and a second, radially outer passage 118 with the shroud 154, the co-axial passages each having air flow turning, i.e., swirler, vanes 156, 157 which impart swirl to the combustion air passing through the premixer. As illustrated, the vanes 156 of the first passage 116 are connected respectively to the center body or hub 152 and the splitter vane 153 and the vanes 157 of the second passage 118 are connected respectively to the splitter vane 153 and the outer wall or shroud 154. In this structure, as in a DACRS swirler, the vanes of the inner and outer arrays are oriented to direct the air flow in respectively opposite circumferential directions.

In the structure illustrated in FIGS. 3, 4 and 5, fuel is fed to the vanes 156, 157 of both the inner and outer vane passages 116, 118, with the fuel being supplied from the inner diameter via annular fuel passage 160. At least some and typically each turning vane contains a gas fuel supply passage 158, 159 through the core of the air foil. The fuel passages distribute gas fuel to at least one gas fuel injection hole 161, 163 defined respectively in the inner and outer arrays of turning vanes.

In the structure illustrated in FIGS. 3-5, gas fuel enters the swirler assembly through inlet port(s) and annular passage(s), which feed the turning vane passages 158, 159, for flow to the fuel inlet(s) 161, 163. The gas fuel begins mixing with combustion air in the swirler assembly 150, and fuel/air mixing is completed in the annular passage 162, which is formed by a center body extension 164 and a swirler shroud extension 166. After exiting the annular passage, the fuel/air mixture enters the combustor reaction zone where combustion takes place.

### BRIEF DESCRIPTION OF THE INVENTION

The invention may be embodied in a burner for use in a combustion system, the burner comprising: an outer peripheral wall; a burner center body coaxially disposed within said outer wall; a fuel/air premixer including an air inlet, at least one fuel inlet, and a splitter vane, the splitter vane defining a first, radially inner passage, with respect to the axis of the center body and a second, radially outer passage with the outer wall, the first and second passages each having air flow turning vane portions which impart swirl to the combustion air passing through the premixer, and a gas fuel flow passage defined within said center body and extending at least part circumferentially thereof, for conducting gas fuel to said fuel/air premixer, wherein said vane portions in each said passage are commonly configured to impart a same swirl direction in each said passage.

The invention may also be embodied in a burner for use in a combustion system, the burner comprising: an outer peripheral wall; a burner center body coaxially disposed within said outer wall; a fuel/air premixer including an air inlet, at least one fuel inlet, and a plurality of splitter vanes disposed between said center body and said outer wall to define at least three radially adjacent annular passages therebetween, each said passage having air flow turning vane portions which impart swirl to the combustion air passing through the premixer; an annular mixing passage defined between said outer wall and said center body, downstream of the turning vane portions, said outer wall extending generally in parallel to said center body and in parallel to said axis of said center body, so that said mixing passage has a substantially constant inner and outer diameter along the length of the center body.

The invention may also be embodied in a method of premixing fuel and air in a burner for a combustion system, the burner including an outer peripheral wall; a burner center body coaxially disposed within said outer wall; a fuel/air premixer including an air inlet, at least one fuel inlet, and a splitter vane, the splitter vane defining a first, radially inner passage, with respect to the axis of the center body and a second, radially outer passage, the first and second passages each having air flow turning vane portions which impart swirl to the combustion air passing through the premixer, said vane portions in each said passage being commonly configured to impart a same swirl direction in each said passage; and a gas fuel flow passage defined within said center body and extending at least part circumferentially thereof, for conducting gas fuel to said fuel/air premixer; the method comprising: (a) controlling a radial and circumferential distribution of incoming air upstream of the fuel inlet; (b) flowing said incoming air into said first and second passages of said swirler assembly; (b) imparting swirl to the incoming air with said turning vane portions; and (c) mixing fuel and air into a uniform mixture downstream of said turning vane portions, for injection into a combustor reaction zone of the burner.

### BRIEF DESCRIPTION OF THE DRAWINGS

FIG. 1 is a schematic illustration of a conventional DACRS type burner;

FIG. 2 is a schematic cross-sectional view of a conventional Swozzle type burner;

FIG. 3 is a schematic cross-sectional view of a prior art burner;

FIG. 4 is a schematic view of the noted portion of FIG. 3;

FIG. 5 is a perspective view of a counter rotating vane pack provided in the prior art burner of FIG. 3;

FIG. 6 is a perspective view of a co-rotating vane pack provided as an embodiment of the invention; and

FIG. 7 is a schematic perspective view illustrating a vane pack configuration according to an alternate embodiment of the invention wherein plural splitter vanes are provided.

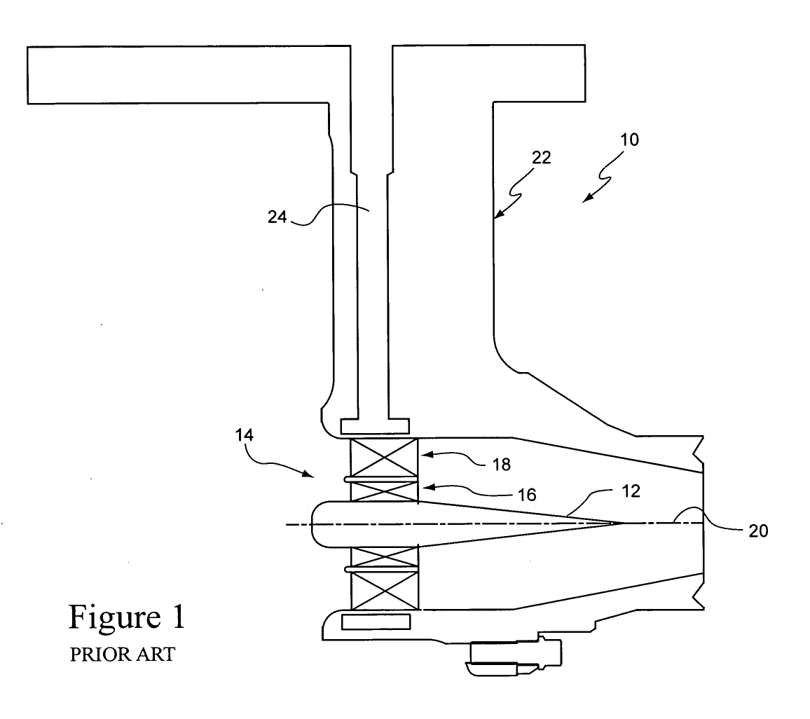

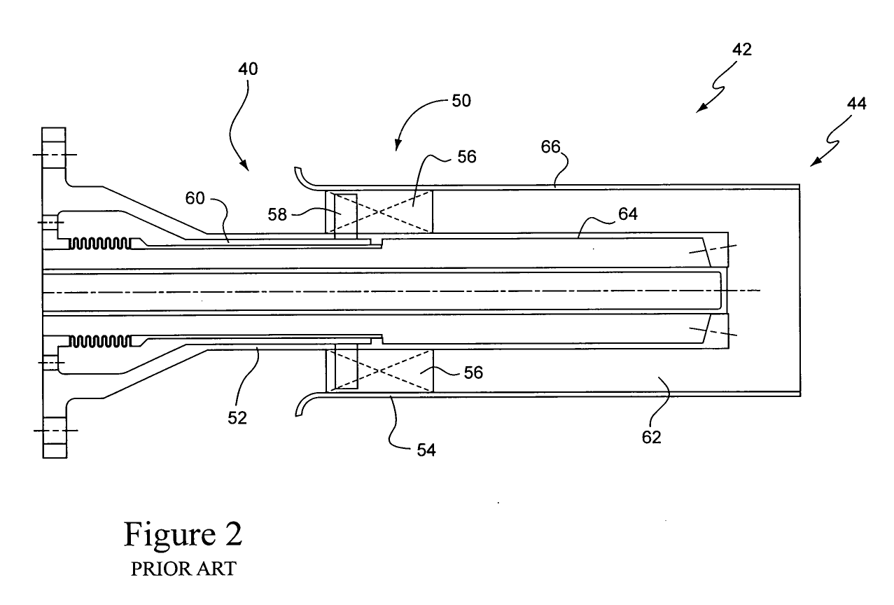

### DETAILED DESCRIPTION OF THE INVENTION

A gas turbine premixer (nozzle) is proposed herein which uses splitter vane(s) to radially divide the premixer flow passages defined by the series of airfoil shaped turning vanes that extend between the center body and the shroud into separate radial passages. Dividing the premixer flow passage into radial sub-sections, tends to reduce the secondary flow motion that occurs in the premixer, owing to the lean of the individual swirler vanes. This radial division will also create smaller flow passages and can lead to increased premixer axial velocities. Higher velocities can help to increase premixer flashback/flameholding resistance. Another benefit is that by appropriately determining the position of the splitter vane or splitter vanes the radial staging of the air/fuel mixture can be controlled. This can yield operability, emissions and thermal benefits within a given combustor.

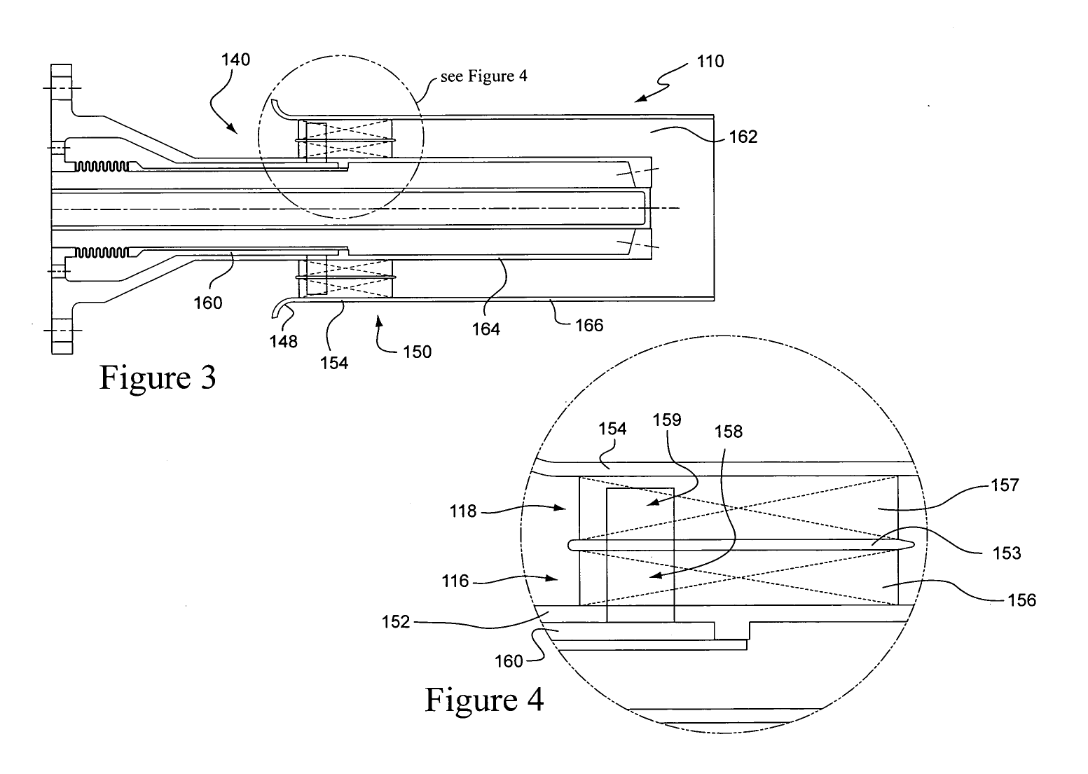

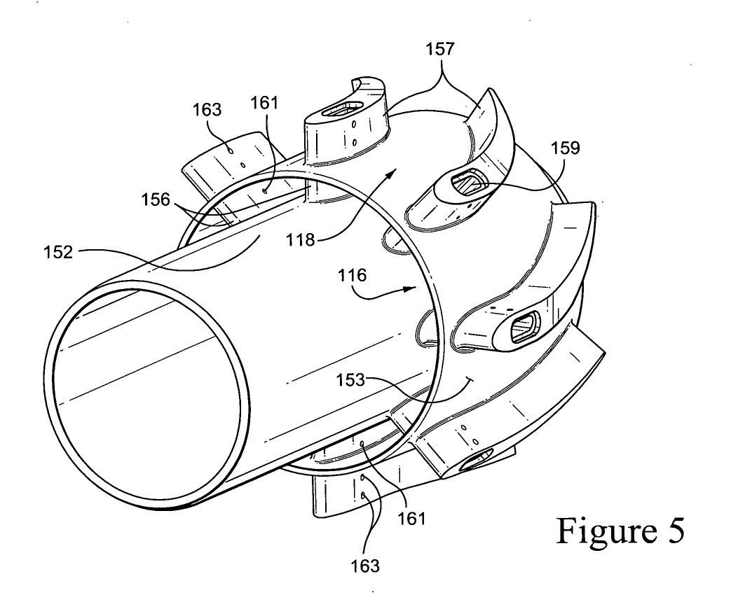

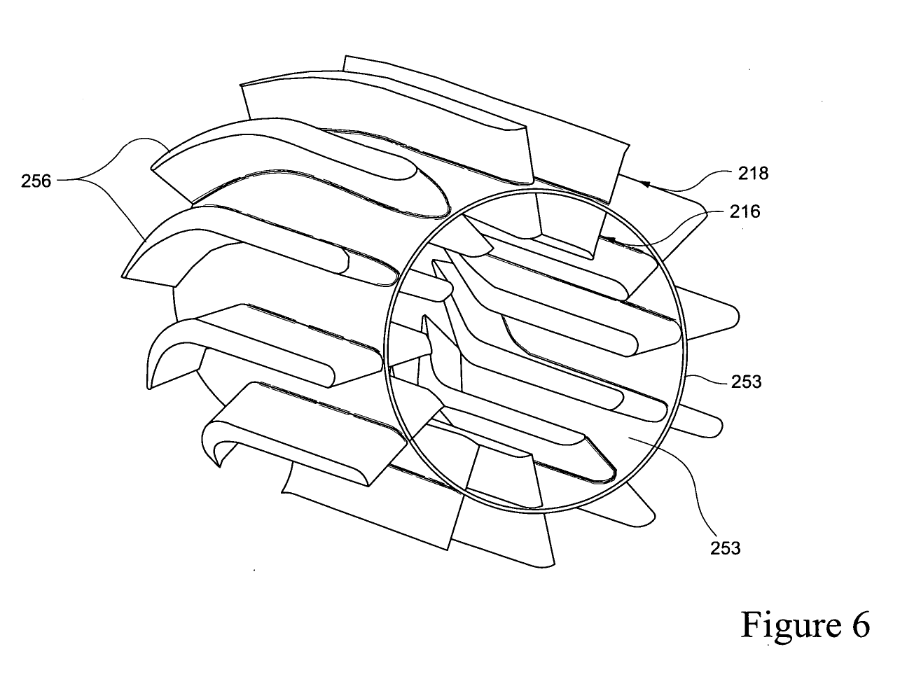

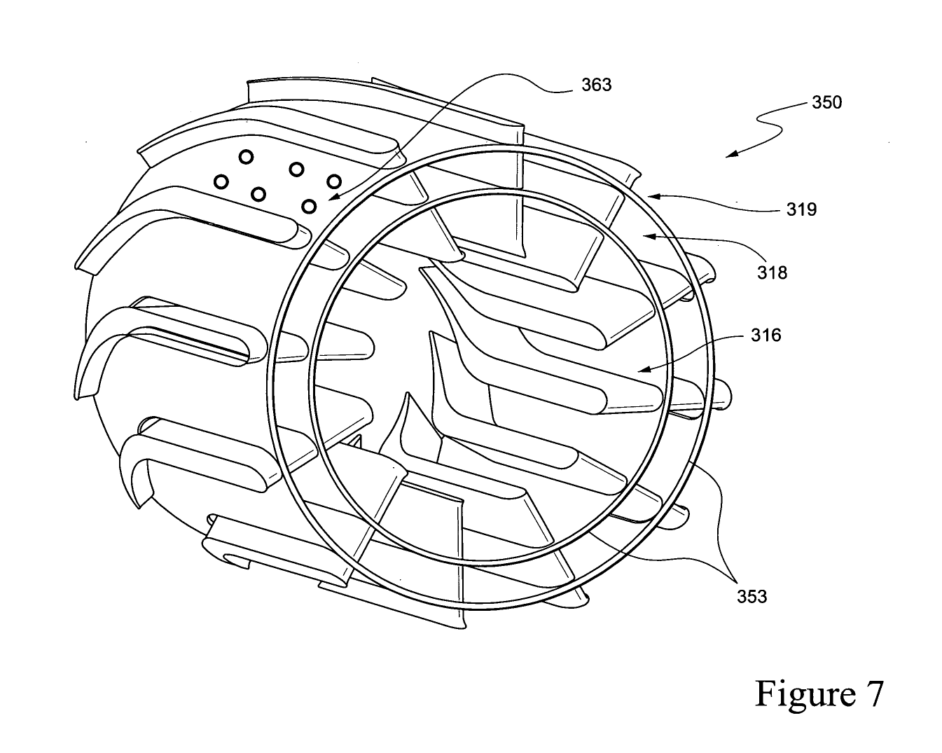

Example embodiments of premixers according to the invention are illustrated in FIGS. 6-7. It is to be understood that the pre-mixer is incorporated in a burner 110 of the type illustrated in FIG. 3, details of which are omitted from FIGS. 6-7 for ease of illustration. Additionally, the turning vanes incorporate fuel supply passages and fuel injection holes as in the structure of FIGS. 3-5, although details thereof are also omitted from FIGS. 6-7 for ease of illustration. In the embodiment of FIG. 6, those component parts generally corresponding to or similarly situated to the structure illustrated in FIGS. 3-5 are labeled with reference numerals generally corresponding to those used above but with the prefix 2 rather than 1. Likewise, in the embodiment of FIG. 7, those component parts generally corresponding to or similarly situated to the structure illustrated in FIGS. 3-5 are labeled with reference numerals generally corresponding to those used above but with the prefix 3 rather than 1.

In the embodiment of FIG. 6, the gas turbine premixer is comprised of a series of airfoil shaped turning vanes 253 for imparting swirl to the combustion air passing through the pre-mixer, the airfoil shaped turning vanes extending between the center body and a shroud (not shown in FIG. 6). As mentioned above, each turning vane includes a gas fuel supply passage through the core of the respective airfoil as in the structure illustrated in FIGS. 3-5. These fuel passages distribute gas fuel to gas fuel injection holes (not shown) that penetrate the wall of the airfoil as in the structure of FIGS. 3-5. The injection holes (fuel inlet injecting fuel into air flowing through the swirler vane assembly) may be located on the pressure side, the suction side or both sides of the turning vanes. Other embodiments provide, in addition or in the alternative, fuel injection from fuel inlets in the shroud or hub or splitter vane(s) so that the turning vanes themselves do not have to have fuel inlets, but they may have flow passages for conducting fuel to the splitter vane(s) or shroud.

The splitter vane(s) may be fabricated using any acceptable manufacturing process (e.g., turning, casting, forming) or a combination thereof. In the embodiment illustrated in FIG. 6, a single splitter vane 253 is illustrated as dividing each premixer flow passage into separate radial passages 216,218. However, as illustrated in FIG. 7, a plurality of splitter vanes 353 may be provided and placed in any radial location within the premixer 350 so that the radial passages 316, 318, 319 do not need to be of uniform radial dimension. Moreover, the distribution of fuel inlets (not shown) within each radial passage may be varied as deemed necessary or desirable.

The shape of the splitter vanes may be determined to provide aerodynamic benefit such as by rounding the leading edge and or tapering the trailing edge. Thus, according to further feature of the invention, the trailing edge of the splitter vane is aerodynamically curved, e.g., elliptically configured. This minimizes the wake or aerodynamic separation are behind the splitter vane, an advantageous features in burners that employ a pre-mixed gas mixture within the burner due to the possibility of a flame stabilizing a holding in the separation zone, which could result in burning of the fuel nozzle itself.

As further illustrated in FIG. 7, a series of holes 363 may be included in the body of the splitter vane(s) 353. In this embodiment, the holes penetrate through the splitter vane. These holes may be introduced via any number of acceptable manufacturing methods (standard or laser drilling, EDM, punching, cast). Likewise, the holes may be of any of a variety of sizes or shapes and may be placed at any of a variety of locations on the body of the splitter vane. The purpose of the holes 363 is to energize the boundary layer that would otherwise form on the surface of the splitter vane 353. This will enhance the flashback/flameholding resistance of the premixer. It should also be noted that the splitter vane placement can be combined with a specifically designed inlet flow conditioner to provide further control of radial fuel/air staging and velocity control.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A burner for use in a combustion system, the burner comprising: an outer peripheral wall; a burner center body coaxially disposed within said outer wall; a fuel/air premixer including an air inlet, at least one fuel inlet, and a splitter vane, the splitter vane defining a first, radially inner passage, with respect to the axis of the center body and a second, radially outer passage, the first and second passages each having air flow turning vane portions which impart swirl to the combustion air passing through the premixer, and a gas fuel flow passage defined within said center body and extending at least part circumferentially thereof, for conducting gas fuel to said fuel/air premixer, wherein said vane portions in each said passage are commonly configured to impart a same swirl direction in each said passage.

2. A burner according to claim 1, wherein at least some vanes of said radially inner passage comprise an internal fuel flow passage, the gas fuel flow passage introducing fuel into said internal fuel flow passages.

3. A burner according to claim 2, wherein said at least one fuel inlet comprises a plurality of fuel metering holes communicating with the internal fuel flow passages.

4. A burner according to claim 1, wherein the trailing edge of the splitter vane is aerodynamically curved to reduce a wake or aerodynamic separation area behind the splitter vane.

5. A burner according to claim 1, further comprising an annular mixing passage downstream of the turning vanes, defined between said outer wall and said center body.

6. A burner according to claim 1, wherein said outer wall extends generally in parallel to said center body.

7. A burner according to claim 5, wherein said outer wall extends generally in parallel to said center body and in parallel to said axis of said center body, so that said mixing passage has a substantially constant inner and outer diameter along the length of the center body.

8. A burner according to claim 1, wherein a series of holes penetrate through said splitter vane.

9. A burner according to claim 1, wherein a plurality of splitter vanes are disposed between said center body and said outer wall whereby at least three annular passages are defined therebetween.

10. A burner for use in a combustion system, the burner comprising: an outer peripheral wall; a burner center body coaxially disposed within said outer wall; a fuel/air premixer including an air inlet, at least one fuel inlet, and a plurality of splitter vanes disposed between said center body and said outer wall to define at least three radially adjacent annular passages therebetween, each said passage having air flow turning vane portions which impart swirl to the combustion air passing through the premixer; an annular mixing passage defined between said outer wall and said center body, downstream of the turning vane portions, said outer wall extending generally in parallel to said center body and in parallel to said axis of said center body, so that said mixing passage has a substantially constant inner and outer diameter along the length of the center body.

11. A burner according to claim 10, wherein a series of holes penetrate through said splitter vane.

12. A burner according to claim 10, wherein said vane portions in each said radially adjacent annular passage are commonly configured impart a same swirl direction in each said passage.

13. A burner according to claim 10, wherein at least some vanes of said radially inner passage comprise an internal fuel flow passage, the fuel inlet introducing fuel into said internal fuel flow passages.

14. A burner according to claim 13, wherein said at least one fuel inlet comprises a plurality of fuel metering holes communicating with the internal fuel flow passages.

15. A burner according to claim 10, wherein the trailing edge of the splitter vane is aerodynamically curved to reduce a wake or aerodynamic separation area behind the vane.

16. A burner according to claim 10, wherein a plurality of splitter vanes are disposed between said center body and said outer wall whereby at least three annular passages are defined therebetween.

17. A method of premixing fuel and air in a burner for a combustion system, the burner including an outer peripheral wall; a burner center body coaxially disposed within said outer wall; a fuel/air premixer including an air inlet, at least one fuel inlet, and a splitter vane, the splitter vane defining a first, radially inner passage, with respect to the axis of the center body and a second, radially outer passage, the first and second passages each having air flow turning vane portions which impart swirl to the combustion air passing through the premixer, said vane portions in each said passage being commonly configured to impart a same swirl direction in each said passage; and a gas fuel flow passage defined within said center body and extending at least part circumferentially thereof, for conducting gas fuel to said fuel/air premixer; the method comprising: (a) controlling a radial and circumferential distribution of incoming air upstream of the fuel inlet; (b) flowing said incoming air into said first and second passages of said swirler assembly; (b) imparting swirl to the incoming air with said turning vane portions; and (c) mixing fuel and air into a uniform mixture downstream of said turning vane portions, for injection into a combustor reaction zone of the burner.

18. A method according to claim 17, wherein at least some vanes of said radially inner passage comprise an internal fuel flow passage, the gas fuel flow passage introducing fuel into said internal fuel flow passages.

19. A method according to claim 17, wherein said at least one fuel inlet comprises a plurality of fuel metering holes for directing fuel in a direction substantially perpendicular to an air flow direction through the premixer.

20. A method according to claim 17, wherein a plurality of splitter vanes are disposed between said center body and said outer wall whereby at least three annular passages are defined therebetween.
